(19) United States
(12) Patent Application Publication
(10) Pub. No.: US 2014/0372032 A1
(43) Pub. Date: Dec. 18, 2014

(54) SYSTEMS, METHODS AND COMPUTER-READABLE MEDIA FOR CONNECTING MAP UNITS IN A DIGITAL WAYFINDING MAP

(71) Applicant: Rivendell Technologies, LLC, Altoona, PA (US)

(72) Inventors: Ethan Canner, Philipsburgh, PA (US); Jonathan McKnight, Morrisdale, PA (US)

(21) Appl. No.: 13/919,716

(22) Filed: Jun. 17, 2013

(51) Int. Cl. G01C 21/00; G01C 21/20

(52) U.S. Cl. CPC G01C 21/00; G01C 21/206
USPC 701/533

(57) ABSTRACT

Systems, methods and computer-readable storage media for generating digital wayfinding maps are described. A system for generating digital wayfinding maps may be configured to connect individual map units, such as map units configured to represent floors in a building. Portal nodes may be arranged on the map units that are configured to represent connection points between map units. Connection elements may be used to connect the map units through the portal nodes. For instance, for a building digital wayfinding map including floor map units, the connection elements may represent elevators, stairways and/or escalators. The connection elements and the portal nodes may be used to connect the map units to generate multi-unit routes that traverse multiple map units. Routes between points of interest on different map units may be presented to a user as a single navigable route using the connection elements and the portal nodes.

### BACKGROUND

Digital mapping technology has evolved beyond conventional road maps representing geographical areas and into the mapping of various real and virtual structures, including buildings, campuses, electronic components, and data maps. In general, destinations in a digital road map are connected through roads on a single plane, namely, the surface of the earth. However, structural maps may include areas on separate planes, levels, surfaces, or the like. For example, a map of a building may provide a separate map image for each floor of the building.

Individuals now rely on digital maps for step-by-step directions. For a structural map, step-by-step directions can require the ability to navigate between separate levels. However, conventional technology does not provide processes for effectively connecting separate map levels, especially in a manner that allows for the generation of straightforward directions between points on each level. As such, structural digital maps are generally static and do not provide navigation features that users have become accustomed to. It will therefore be desirable to generate a digital map using processes configured to connect map levels in a multi-level digital map in an efficient and cost-effective manner that provides navigation features between the map levels.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for connecting a plurality of map units of a digital wayfinding map may comprise a processor and a non-transitory, computer-readable storage medium in operable communication with the processor. The computer-readable storage medium may contain one or more programming instructions that, when executed, cause the processor to access the plurality of map units, in which each of the plurality of map units comprises at least one of a plurality of nodes. The computer-readable storage medium may also contain one or more programming instructions that, when executed, cause the processor to receive a plurality of portal nodes arranged on at least two of the plurality of map units, receive at least one connection element configured to indicate a connection between at least two of the plurality of map units through at least two of the plurality of portal nodes, and generate at least one multi-unit route between at least two of the plurality of nodes of the at least two map units using the at least one connection element.

In an embodiment, a computer-implemented method for connecting a plurality of map units of a digital wayfinding map, by a processor, may comprise accessing the plurality of map units, in which each of the plurality of map units comprising at least one of a plurality of nodes. The method may further comprise receiving a plurality of portal nodes arranged on at least two of the plurality of map units, receiving at least one connection element configured to indicate a connection between at least two of the plurality of map units through at least two of the plurality of portal nodes, generating at least one multi-unit route between at least two of the plurality of nodes of the at least two map units using the at least one connection element. In an embodiment, a computer-readable storage medium may include computer-readable program code configured to connect a plurality of map units of a digital wayfinding map embodied therewith. The computer-readable program code may comprise computer-readable program code configured to access the plurality of map units, in which each of the plurality of map units comprises at least one of a plurality of nodes. The computer-readable program code may further comprise computer-readable program code configured to receive a plurality of portal nodes arranged on at least two of the plurality of map units, receive at least one connection element configured to indicate a connection between at least two of the plurality of map units through at least two of the plurality of portal nodes, generate at least one multi-unit route between at least two of the plurality of nodes of the at least two map units using the at least one connection element.

### BRIEF DESCRIPTION OF THE DRAWINGS

The above and other objects of the present invention will become more readily apparent from the following detailed description taken in connection with the accompanying drawings.

FIG. 1 depicts an illustrative digital wayfinding map according to some embodiments.

FIG. 2 depicts an illustrative digital wayfinding map system according to some embodiments.

FIGS. 3A-3C depict an illustrative example of generating a portion of a digital wayfinding map according to some embodiments.

FIG. 4 depicts a flow diagram for an illustrative method for generating a digital wayfinding map according to some embodiments.

FIG. 5 illustrates various embodiments of a computing device for implementing the various methods and processes described herein.

### DETAILED DESCRIPTION

The described technology is directed to systems, methods and computer-readable storage media for generating digital wayfinding maps and routes between points associated therewith. In general, a digital wayfinding map may include a graphical representation of an area, such as a geographic location and/or a structure, and routes for navigating between points within the area. For example, a digital wayfinding map may be configured to represent a city and may include routes for traveling between locations in the city, such as buildings, addresses and streets. In another example, a digital wayfinding map may represent an indoor space, such as the interior of a building, and may include routes for navigating between rooms, floors, entrances, elevators, stairs, or other points of interest within the building. Non-limiting examples of buildings include hospitals, office buildings, school buildings, convention centers, sports stadiums and arenas, hotels, manufacturing facilities, and shopping centers. In a further example, a digital wayfinding map may be configured to represent both indoor and outdoor spaces, such as a college campus, a medical campus, an amusement park, a zoo, a public transportation system, or a geographical area including buildings. For example, a digital wayfinding map may be configured to provide directions from a room in a first building to a room in a second building via an outdoor path.

According to some embodiments, a digital wayfinding map may include multiple individual units (“map units”) that represent various elements, components, areas and/or portions thereof of the structure and/or area depicted in the digital wayfinding map. For instance, a map unit may include a floor in a building, a building on a campus, a circuit board in an electronic device, a group in a social graph, or the like. The map units may be connected using various connection elements, including, without limitation, doorways and/or other unit interfaces, tunnels, bridges, stairs, elevators, escalators, ramps (for example, for handicap accessibility), roads, public transportation routes, airline routes, virtual connections (for example, social graph relationship connections), or circuits. In an embodiment, a map unit may include one or more portals configured to provide connections to other map units through a connection element. For instance, a floor map unit may include a portal configured as a stairway entrance that is connected to a stairway entrance portal of another floor through a staircase connection element.

In an embodiment, each map unit may be on a separate plane, level, system, or other formation such that navigation therebetween requires a specific multi-unit connection. For example, floor map units in a building digital wayfinding map may require connections such as a stairway or elevator for navigation between floors. In another example, geographical area map units may be separated by a structure, such as a body of water, requiring an airline route connection to navigate between geographical areas.

According to some embodiments, a digital wayfinding map may be accessible through a map application executed by a logic device, such as a server, personal computer (PC), tablet computing device, kiosk computing system, smartphone, or the like. The map application may be configured to manage various information elements, including, without limitation, files, data, route generation processes, and/or user input associated with the digital wayfinding map. A user may access the digital wayfinding map through a display component in operable communication with the logic device executing the map application. For example, the map application may be configured to render an image of an area on the display component and to access a database including digital signage locations and/or points of interest for display on the image. The map application may receive user input indicating a starting point and a destination point and may generate a lowest-cost route (for example, the “best” route based on various criteria and/or factors) for display on the image of the area. For instance, kiosk computing devices may be located at the entrances of a stadium. A visitor may select a destination, such as a seating section, from a kiosk computing device at a particular entrance to receive the shortest-distance directions to the destination.

A digital wayfinding map may include, without limitation, one or more map units, nodes arranged within the one or more map units, lines connecting the nodes, routes between the nodes, and processes for determining the lowest-cost route from a starting point to a destination point. In an embodiment, a map unit may include an individual graphical representation within the digital wayfinding map. A non-limiting example of a map unit may include a geographical location, a structure, an object, or portions thereof. For instance, a digital wayfinding map may be configured for a building and may include a map unit for each floor and a map unit representing the area immediately surrounding the building, such as the parking area for the building. In another instance, a digital wayfinding map may be configured for a geographical region and may include map units representing a certain defined area of the geographical region, such as square area units (for example, “tiles”) or defined sub-regions (for example, a city, a suburb, a university campus, or the like). In a further instance, a digital wayfinding map may be configured for an electronic device and may include a map unit for each circuit board with routes configured to indicate data flow within the electronic device.

The nodes may be configured to represent points of interest within the digital wayfinding map, such as countries, states, cities, towns, streets, addresses, buildings, floors and/or rooms within a building, or the like. In an embodiment, the particular points of interest available and/or visible to a user may depend on the selected level of detail (for example, the “zoom level”) for the digital wayfinding map. Nodes may be connected to other nodes through lines, for example, representing paths between the nodes. Lines are not limited to straight lines, but may include, without limitation, arcs, curves, paths, roadways, hallways, pedestrian walkways, waterways, stairs, escalators, elevators, public transportation routes, airline routes, and any other structure or form capable of connecting or representing a connection between nodes. A map application and/or a route generation application may be configured to generate navigable routes between nodes using the paths. For example, a map application may present a highlighted path on the map unit from a start node to a destination node within the map unit.

In general, a developer may use a map development application or map management application to generate a digital wayfinding map configured to be managed by the map application and/or route generation application. The developer may create and/or access a map unit, such as an image file (for example, a .jpg, .bmp, .tiff, or the like) of a floor of a building, a geographical area or a component of a device using the map development application. The developer may then position a node on each point of interest on the map unit so that a user may interact with the point of interest within the digital wayfinding map. For instance, a node object may be placed on the map unit at each point of interest, such as a street address on a geographical area map unit or a room in a building floor map unit.

Existing technology provides that the developer is required to configure each map unit individually, for example, without the ability to connect the map units and generate comprehensive routes that span multiple map units. As such, digital wayfinding maps having multiple map units heretofore were not capable of providing accurate navigation functions between multiple map units without cumbersome and complicated workarounds.

Accordingly, embodiments described herein provide for the efficient and cost-effective generation of digital wayfinding maps including comprehensive navigation routes between multiple map units. In an embodiment, a map developer application may be configured to receive portal nodes on one or more map units of a digital wayfinding map. The portal nodes may be configured to designate a connection point between map units. The map developer application may receive connection elements configured to connect map units through the portal nodes. Navigation routes between nodes on different map units may be generated by the map developer application using the connection elements and the portal nodes. In an embodiment, the nodes, connection elements, map units, and/or portal nodes may be formed into one or more groups. The groups may be used for, among other things, to create and/or specify one or more characteristics common to members of the group.

Embodiments described herein may provide multiple technological advantages for digital wayfinding maps and for systems and methods for generating digital wayfinding maps. A non-limiting example of such an advantage is the more efficient and cost-effective creation of digital wayfinding maps and navigation routes between multiple map units of digital wayfinding maps than possible using existing technology.

Digital wayfinding maps configured according to embodiments are not limited to geographical areas or buildings, as any object capable of being represented through a routable map structure is contemplated herein, including, without limitation, electronic circuits, communication networks, social networks, supply chain networks, waterways, plumbing systems, electrical systems, and/or heating, ventilation, and air conditioning (HVAC) systems.

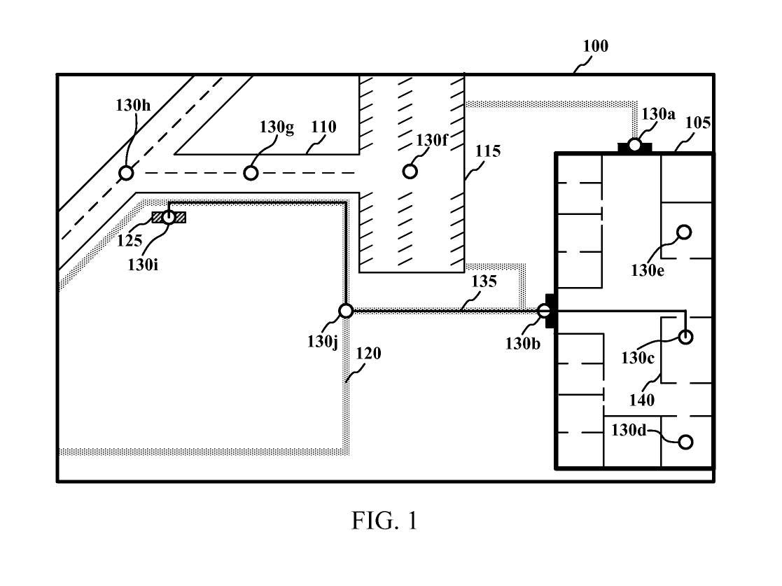

FIG. 1 depicts an illustrative digital wayfinding map according to some embodiments. As shown in FIG. 1, a digital wayfinding map 100 may include various graphical elements representing real-world objects within the area shown in the digital wayfinding map. Illustrative and non-restrictive graphical elements include a building 105, roads 110, a parking lot 115, a sidewalk 120, and a bus stop 125. Various nodes, or points of interest, may be designated on the digital wayfinding map, such as building entrances 130a, 130b, rooms within the building 130c-130e, the parking lot 130f, roads 130g, 130h, the bus stop 130i, and a sidewalk intersection 130j. A digital wayfinding map 100 configured according to some embodiments provided herein is not limited to the type and/or number of graphical elements and/or nodes described in association with FIG. 1, as those are for illustrative purposes only. Indeed, any type and/or number of graphical elements and/or nodes may be included in a digital wayfinding map 100.

The nodes 130a-130j may be configured to provide selectable and/or navigable points within the digital wayfinding map 100. For example, a node 130a-130j may be selected by a user to provide further information about the point of interest associated with the node, including, without limitation, names, addresses, latitude, longitude, distances from other nodes, or combinations thereof. According to some embodiments, a user may select nodes 130a-130j to receive directions for traveling between two or more nodes within the digital wayfinding map. For example, a user may be accessing the digital wayfinding map 100 using a logic device, such as a kiosk computing device, within room 140. The user may seek to find directions to the nearest bus stop 125 from their current location, designated on the digital wayfinding map 100 by node 130c. According to some embodiments, the map application may determine the nearest bus stop 125 or the user may select their current location, node 130c, and then select node 130h. The map application may generate the lowest-cost path 135 for the user to travel from their current location, node 130c, to their destination, node 130h.

In an embodiment, the map application may be configured to determine the lowest-cost path between all of the nodes 130a-130j using various path selection factors. Non-limiting examples of path selection factors for determining the lowest-cost path include time, distance, safety, popularity, environment, time of day, personal preferences, weather, or the like. For example, a user may prefer walking paths that are a combination of the shortest distance and proximity to main roadways. In another example, a walking path between two lecture halls on a college campus may be different in the wintertime, using more paths through connected buildings, as compared to the summertime. In an embodiment, the lowest-cost paths between the nodes may be determined based on an automated process, such as Djikstra's algorithm and/or the A-star algorithm, to determine the shortest path between the nodes, including the nodes created at intersecting paths. In an embodiment, at least a portion of the path may be determined by the user. For example, the user may select three or more nodes on the digital wayfinding map and a path may be generated giving the user the lowest-cost path to travel to all of the selected nodes. In an embodiment, the lowest-cost paths may be determined based on a combination of path selection factors, an automated process, and/or a user selected portion of the path.

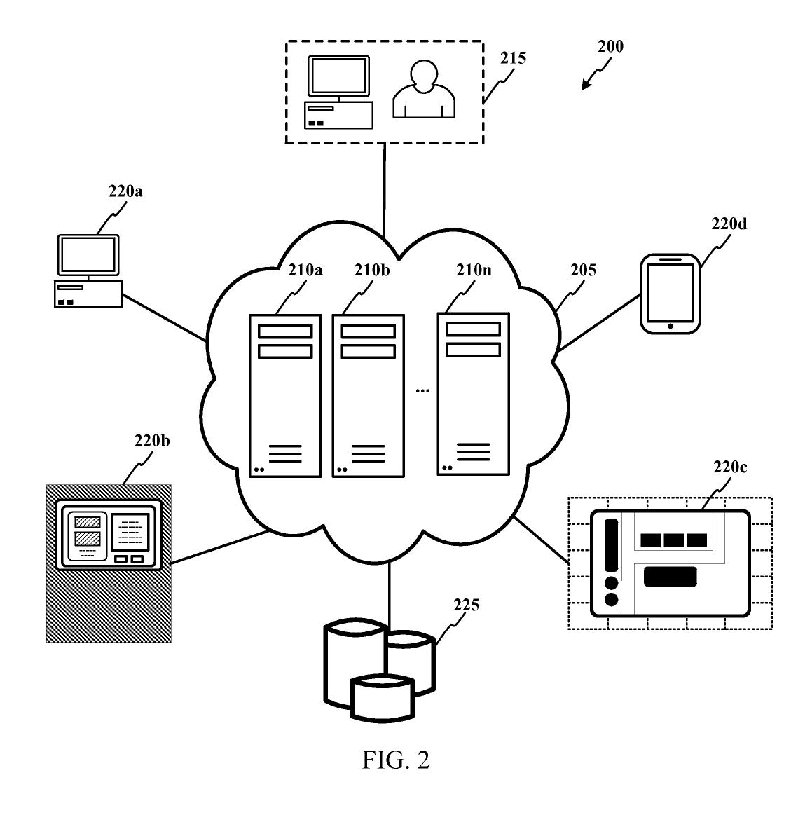

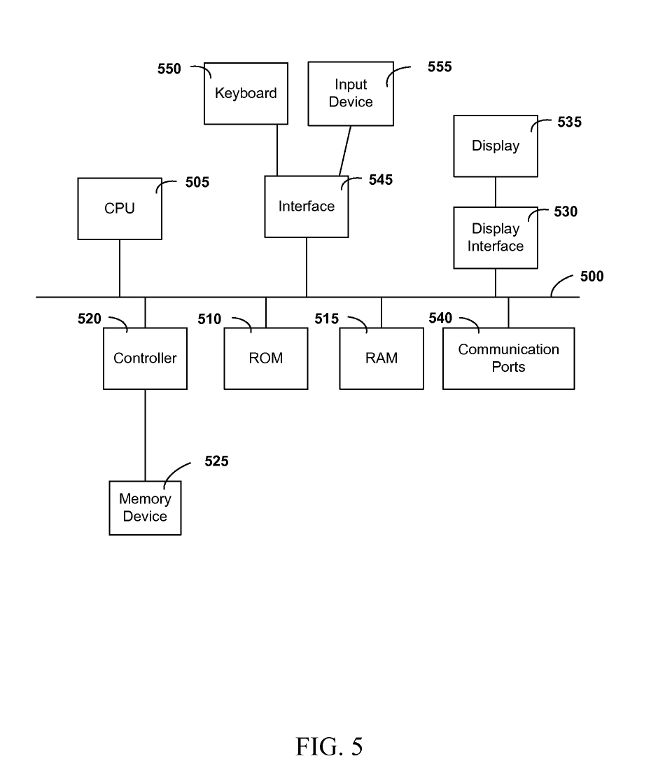

FIG. 2 depicts an illustrative digital wayfinding map system according to some embodiments. As shown in FIG. 2, a digital wayfinding map system 200 may include one or more computing devices 210a-210n, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 540, controller 520, and/or memory device 525 depicted in FIG. 5 and described below in reference thereto. In an embodiment, the programming instructions may include a map application configured to present a digital wayfinding map on a display component in operable communication with a logic device, including, but not limited to, a server computing device 210a-210n, a personal computer (PC) 220a, a kiosk computing device 220b, a wall-mounted computing device 220c, a mobile computing device 220d, such as a laptop computer, smartphone, personal digital assistant (PDA), tablet computing device, or any other logic and/or computing device now known or developed in the future. For example, the map application may be configured to provide visitors with directions to points of interest within a building using a digital wayfinding map presented on kiosk computing devices 220b and/or wall-mounted computing devices 220c positioned at various locations throughout the building. In another example, a user may access a digital wayfinding map for a geographical region using a smartphone mobile computing device 220d to determine the lowest-cost route to travel between locations within the geographical region.

In some embodiments, the map application may be accessible through various platforms, such as a client application, web-based application, over the Internet, and/or a mobile application (for example, a “mobile app” or “app”). According to some embodiments, the map application may be configured to operate on each logic device 210a-210n, 220a-220d and/or to operate on a server computing device accessible to logic devices over a network 205, such as the Internet. All or some of the files, data and/or processes (for example, route generating processes) associated with each digital wayfinding map may be stored locally on each logic device 210a-210n, 220a-220d and/or stored in a central location and accessible over a network 205.

In an embodiment, one or more data stores 225 may be accessible by the logic devices 210a-210n, 220a-220d for the generation and/or presentation of the digital wayfinding maps. For example, the one or more data stores 225 may include, without limitation, images, node data, path data, network data, device data, user profile data, and/or metadata associated therewith. In another example, the one or more data stores 225 may include third-party data sources that may be used to generate a digital wayfinding map and/or routes between nodes presented on the digital wayfinding map. For instance, a third-party data source may include blueprint images for a building, information to present to a user responsive to selection of a node, such as a hyperlink associated with a business having an address associated with a particular node, a social graph service, or the like. The one or more data stores 225 may include various information resources. Illustrative and non-restrictive examples include databases, digital files, such as digital documents (for example, image files, maps, blueprints, or the like), websites, multimedia files, audio files, video files, or the like. Accordingly, embodiments are not limited to any particular form of information resource as any form in existence or developed in the future capable of operating according to embodiments is contemplated herein.

Although the one or more data stores 225 are depicted as being separate from the logic devices 210a-210n, 220a-220d, embodiments are not so limited, as all or some of the one or more data stores may be stored in one or more of the logic devices.

In an embodiment, a map development application 215 may be provided to generate the digital wayfinding maps, the map application, map data, and/or map images. The map development application 215 may be executed on a logic device, such as logic devices 210a-210n, 220a-220d. In an embodiment, the map development application 215 may be configured to generate and/or update a digital wayfinding map and to provide access to the new and/or updated digital wayfinding map to logic devices 210a-210n, 220a-220d within the system 200. According to some embodiments, the map development application 215 may be a module of the map application, and vice versa. The map development application 215 may include various modules, tools, or the like for generating digital wayfinding maps. For instance, the map development application 215 may include modules configured to access image files, create map units, add structures, add geographical areas, add lines (for example, paths, elevators, stairs, escalators), generate routes, test routes, add points of interest, and add information related thereto.

According to some embodiments, a route generation application or module may operate on one or more of the logic devices 210a-210n, 220a-220d within the system 200. The route generation module may be configured to generate routes based on information obtained from the map development application 215 and/or the one or more data stores 225. For instance, the route generation application may generate a route and/or obtain an existing route in response to a request from the map application operating on one or more of the logic devices 210a-210n, 220a-220d. According to some embodiments, routes between nodes may be generated by the map development application and/or route generation application and saved, for instance, in the one or more data stores 225. Responsive to a request to generate a route between nodes, the map development application 215 and/or the route generation application may determine whether a route between the nodes already exists. The existing route may be used as the generated route such that the route does not need to be re-generated. The map development application 215 and/or the route generation application may determine whether changes along the route have occurred and may modify the route to incorporate the changes (for instance, the addition/removal of a node).

In an embodiment, the route generation application may operate on a server computing device 210a-210n and may be accessed by the map application through one or more interfaces, such as an application programming interfaces (APIs). In an embodiment, the route generation application may be a standalone software application operating between the map application and the map development application. For instance, the route generation application may receive requests from the map application to generate a route and the route generation application may communicate with the map development application to obtain information associated with generating the requested route. In an embodiment, the route generation application may be a module of the map application and/or the map development application.

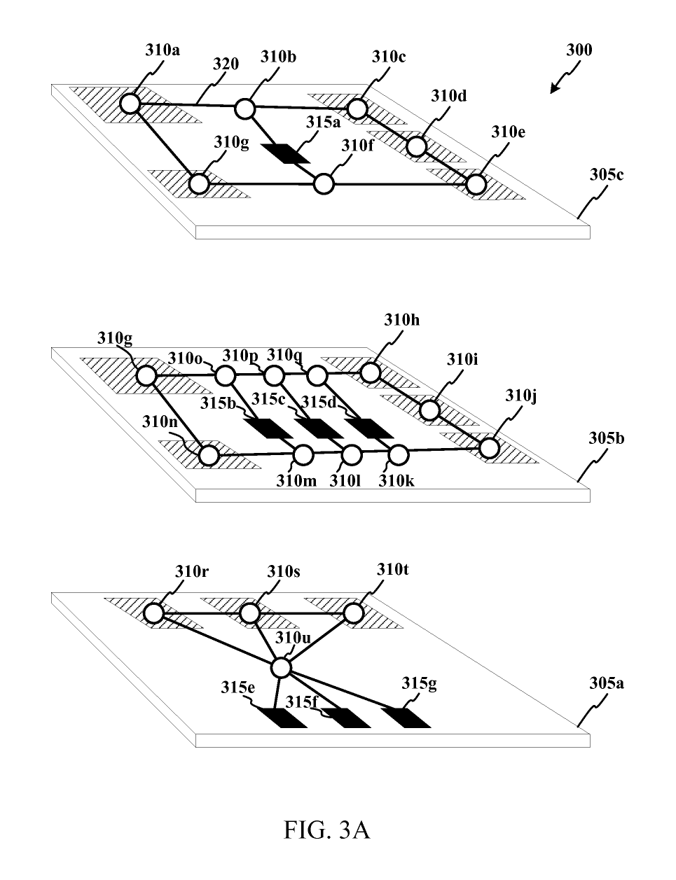

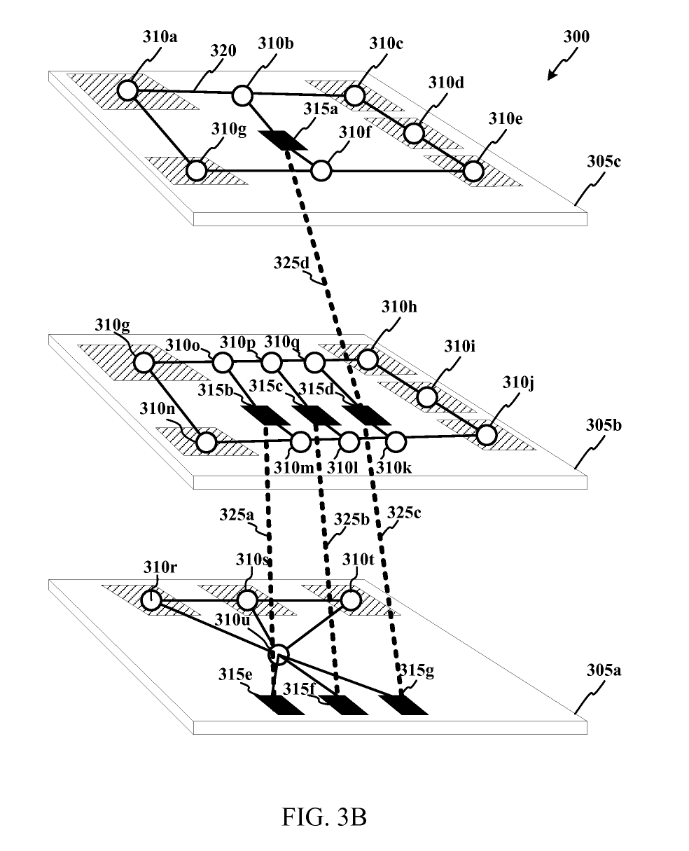

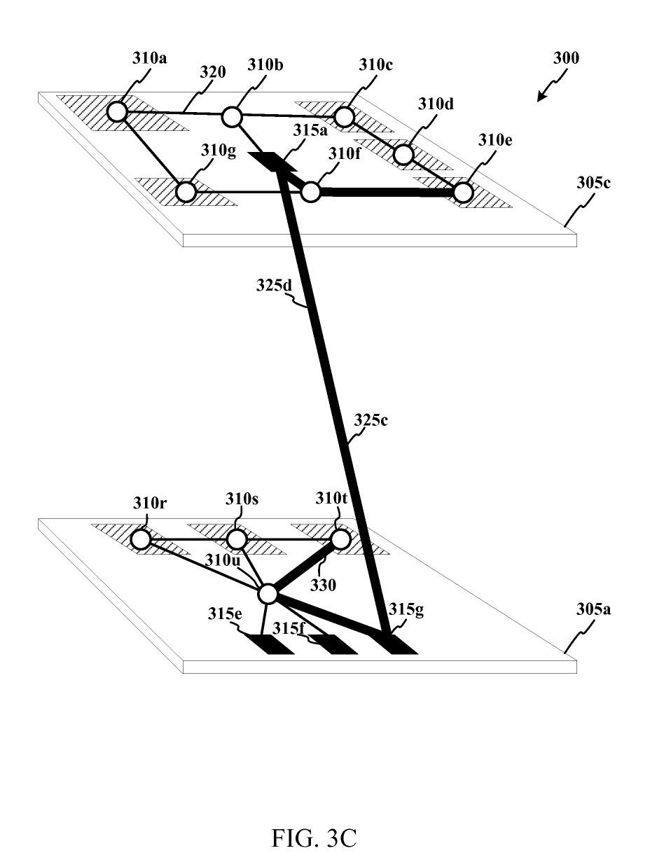

FIGS. 3A-3C depict an illustrative example of generating a portion of a digital wayfinding map according to some embodiments. As shown in FIG. 3A, a digital wayfinding map 300 may include multiple map units 305a-305c. In the non-limiting example depicted in FIGS. 3A-3C, the map units 305a-305c represent the floors in a building, for instance, where the first floor (ground floor) is represented by map unit 305a, the second floor is represented by map unit 305b and the third floor is represented by map unit 305c. Each map unit 305a-305c includes various nodes 310a-310u configured to represent various points of interest, such as rooms of the building. The nodes 310a-310u may be connected by lines 320 (although FIGS. 3A-3C depict multiple lines, only one reference number is used to simplify the figures).

The map development application 215 may receive one or more portal nodes 315a-315g on the map units 305a-305c configured to designate a connection point between map units. The portal nodes 315a-315g may be configured to represent various types of connections between floors in a building, including, without limitation, stairways, elevators and/or escalators. For instance, if portal node 315a and portal node 315d are connected through an elevator connection element, portal node 315a and portal node 315d may represent elevator shaft interfaces, such as elevator doors, providing entrance to the elevator that operates between map unit 305b and map unit 305c.

In FIG. 3B, the map development application 215 may receive connection elements 325a-325d on the digital wayfinding map 300. Connection element 325a and connection element 325b may be configured as escalators operating between map unit 305a and map unit 305b. In an embodiment, portal nodes 315a-315g and/or connection elements 325a-325d may be configured to have one or more navigation characteristics, such as directionality, map unit limitations, or the like. For instance, connection element 325a may be configured as an “up” escalator configured to provide access from map unit 305a up to map unit 305b. Conversely, connection element 325b may be configured as a “down” escalator configured to provide access from map unit 305b down to map unit 305a. Connection element 325c and connection element 325d may be configured as an elevator operable to provide access up and down to map units connected thereto. For example, connection element 325c may provide access between map unit 305a and map unit 305b and connection element 325d may provide access between map unit 305b and map unit 305c. Embodiments are not limited to these connection element characteristics, as any other type of characteristic capable of operating according to embodiments is contemplated herein. For instance, a connection element 325a-325d may be configured to operate only between certain floors, such as floors 1-10 of a twenty-floor building.

The connection elements 325a-325d and portal nodes 315a-315g provide the ability to connect individual map units 305a-305c in a digital wayfinding map 300 to allow a user to interact with the digital wayfinding map as a single entity instead of a collection of separate map units. As shown in FIG. 3B, the digital wayfinding map application 215 may generate routes that span multiple map units 305a-305c. For instance, a user interacting with the digital wayfinding map 300 may seek to travel from a room on map unit 305a represented by node 310t to a room on map unit 305c represented by node 310c. The digital map application may present the user with the digital wayfinding map 300 depicted in FIG. 3C, providing the route 330, or path, from node 310t, node 310u, portal node 315g, the elevator traveling along connection element 325c and connection element 325d, portal node 315a, node 310f, and to node 310c.

The route 330 may be generated using various processes according to some embodiments described herein. For example, given a starting point on map unit 305a and an ending point on map unit 305c, the map development application 215 and/or map application may determine the preferred route based on one or more factors and/or processes. In an embodiment, the map development application 215 and/or map application may determine the lowest cost of getting to each connection element 325a-325c on map unit 305a and then determine the cost of getting to the destination from each portal node 315a on map unit 315c. The map development application 215 and/or map application may determine the lowest-cost route by comparing the paths with the lowest cost based on various factors and/or processes, as described above. The example digital wayfinding map 300 depicted in FIGS. 3A-3C may have a limited number of routes 330 due to the low number of portal nodes 315a-315g and connection elements 325a-325d compared to actual digital wayfinding maps, as digital wayfinding map 300 is provided for illustrative purposes only. Accordingly, the processes for determining the lowest-cost routes may include a greater number of alternative routes 330 and route components, such as portal nodes 315a-315g and connection elements 325a-325d.

As shown in FIG. 3C, map units 305a-305c that are not a direct part of a route 330 may be removed, obscured, hidden, or otherwise rendered non-visible in whole or in part from the presentation of a digital wayfinding map route. In this manner, the entire digital wayfinding map 300 and/or data associated therewith does not have to be presented to the user when a path 330 is being generated. As such, resources may be conserved when presenting navigation functions to a logic device, which may be particularly useful for client applications, web-based applications, mobile applications, or the like.

In an embodiment, the map development application 215 may be configured to provide one or more user specified paths 330 between map units 305a-305c. For example, the map development application 215 may be configured to provide a path 330 that is handicap accessible (for instance, a path without stairs and/or with ramps for wheel chairs, strollers, or the like) and/or that avoids certain areas (for instance, the emergency room in a hospital or a busy intersection on a campus). The generated paths 330 may be stored in a data storage location, such as an electronic file (for example, an extensible markup language (XML) file) and/or one or more data stores 225. For instance, the map development application 215, map application, and/or route generation application may store the nodes 310a-310u, portal nodes 315a-315g, lines 320, connection elements 325a-325d, and/or information associated therewith for each map unit and possible routes therebetween.

In an embodiment, various digital wayfinding map components may be formed into one or more groups, such as map units 305a-305c, nodes 310a-310u, portal nodes 315a-315g, lines 320, and/or connection elements 325a-325d. The groups may be used, among other things, to create and/or specify one or more characteristics common to members of the group. For example, each member of the group may be disabled by setting a “disabled” property of the group to “true,” and vice versa. For instance, a group may be disabled in the case of a fire, maintenance, the time of day, or other condition requiring that all members of the group be disabled/enabled. In an embodiment, the map application may select a route that does not include disabled digital wayfinding map components. In another example, portal nodes 315a-315g and/or connection elements 325a-325d may be grouped according to directionality (for instance, an “up” group and a “down” group). In a further example, components may be grouped according to function, such as an “elevator” group, a “stairway” group, an “escalator” group, or the like.

In an embodiment, the map development application 215 may include various modules for generating routes 330 between the nodes and/or map units. For instance, a node route module may operate to generate routes between nodes 310a-310u, 315a-315g on each individual floor and a map unit route module may operate to determine routes between map units 305a-305c. In a non-limiting example using the route 330 depicted in FIG. 3C, the node route module may operate to determine the lowest-cost path between node 310t and a portal node 315a-315g that may access map unit 305c, where destination node 310e is located and to determine the lowest cost path between portal node 315a to destination node 310e on map unit 301c. The map unit route module may determine the lowest-cost path between map unit 310a and 310c, which is through the elevator represented by connection elements 325c and 325d.

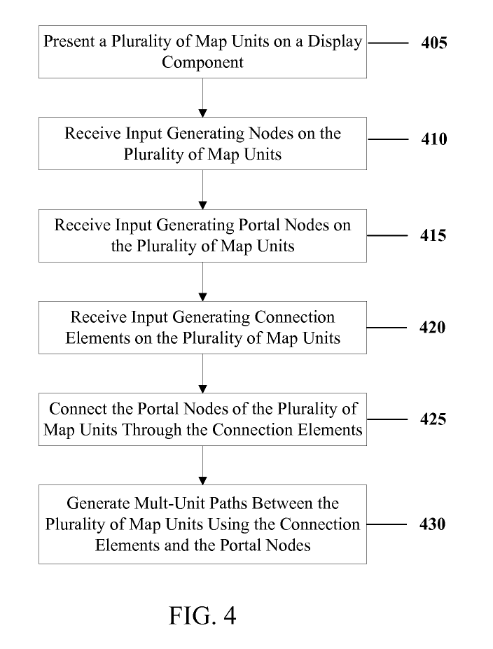

FIG. 4 depicts a flow diagram for an illustrative method for generating a digital wayfinding map according to some embodiments. A plurality of map units may be presented 405 on a display component. For instance, a map development application may be configured to present 405 a plurality of map units to a developer on a display component in operable communication with a logic device executing the map development application. In this manner, the developer may view and update the map unit to generate a digital wayfinding map. In a non-limiting example, the plurality of map units may be configured to represent floors in a building depicted in a digital wayfinding map.

The map development application may receive 410 input from an input device generating nodes on the plurality of map units. The nodes may be configured to represent points of interest on the map units. For instance, the nodes may represent rooms in a floor map unit. The nodes may be connected using lines configured to provide a path between the nodes, such as a hallway between the rooms of the floor map unit. The map development application 215 may receive 415 input generating portal nodes on the plurality of map units. According to some embodiments, the portal nodes may be configured to represent connections between map units, such as an elevator shaft, stairway entrance, or the like. Each portal node may connect a map unit to another map unit. In addition, lines may be used to connect a portal node to one or more nodes, for instance, to represent that a node may be reached by entering the map unit through the connected portal. Input may be received 420 by the map development application generating connection elements on the plurality of map units. In some embodiments, the connection elements may be configured to connect the portal nodes of the map units. For instance, a connection element may be configured to represent an elevator operating between a portal node on a first map unit and a portal node on a second map unit.

The map development application may connect 425 the portal nodes of the plurality of map units through the connection elements. In this manner, the map development application may use the connection elements as paths between map units. Accordingly, the map development application may generate 430 multi-unit paths between the plurality of map units using the connection elements and the portal nodes. For instance, in a digital wayfinding map including five map units representing five floors of a building, the map development application 215 may generate a route from a node on the first floor to a node on the fifth floor using the multi-unit paths. Accordingly, the map application may present the route to the user as a single map connected through the connection elements and the portal nodes.

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above. For example, the memory devices 525 may be configured to store information associated with the one or more data stores 225.

Program instructions, software or interactive modules for performing any of the functional steps associated with the analysis of judicial decision making as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. The information may include information related to a current job ticket and associated tasks. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A system for connecting a plurality of map units of a digital wayfinding map, the system comprising:
a processor; and
a non-transitory, computer-readable storage medium in operable communication with the processor, wherein the computer-readable storage medium contains one or more programming instructions that, when executed, cause the processor to:
access the plurality of map units, each of the plurality of map units comprising at least one of a plurality of nodes;
receive a plurality of portal nodes arranged on at least two of the plurality of map units;
receive at least one connection element configured to indicate a connection between at least two of the plurality of map units through at least two of the plurality of portal nodes; and
generate at least one multi-unit route between at least two of the plurality of nodes of the at least two map units using the at least one connection element.

2. The system of claim 1, further comprising a display component operatively coupled to the processor,
wherein the computer-readable storage medium further contains one or more programming instructions that, when executed, cause the processor to present the digital wayfinding map on the display component.

3. The system of claim 2, wherein the one or more programming instructions that, when executed, cause the processor to present the digital wayfinding map on the display component comprise one or more programming instructions that, when executed, cause the processor to only present map units along the at least one multi-unit route on the display component.

4. The system of claim 1, wherein the digital wayfinding map is configured to represent at least one of a building, a circuit or a campus.

5. The system of claim 1, wherein the digital wayfinding map is configured to represent a building and each of the plurality of map units are configured to represent a floor in the building.

6. The system of claim 1, wherein the at least one connection element is associated with a directionality characteristic.

7. The system of claim 1, wherein the at least one connection element comprises at least one of a doorway, a ramp, an escalator, an elevator, or a stairway.

8. The system of claim 1, further comprising a transceiver configured to communicate with one or more logic devices,
wherein the computer-readable storage medium further contains one or more programming instructions that, when executed, cause the processor to transmit the digital wayfinding map to the one or more logic devices.

9. A computer-implemented method for connecting a plurality of map units of a digital wayfinding map, the method comprising, by a processor:
accessing the plurality of map units, each of the plurality of map units comprising at least one of a plurality of nodes;
receiving a plurality of portal nodes arranged on at least two of the plurality of map units;
receiving at least one connection element configured to indicate a connection between at least two of the plurality of map units through at least two of the plurality of portal nodes; and
generate at least one multi-unit route between at least two of the plurality of nodes of the at least two map units using the at least one connection element.

10. The method of claim 9, further comprising presenting the digital wayfinding map on a display component operatively coupled to the processor.

11. The method of claim 10, wherein presenting the digital wayfinding map comprises presenting only map units along the at least one lowest-cost route are presented in the digital wayfinding map on the display component.

12. The method of claim 9, wherein the digital wayfinding map is configured to represent at least one of a building, a circuit or a campus.

13. The method of claim 9, wherein the digital wayfinding map is configured to represent a building and each of the plurality of map units are configured to represent a floor in the building.

14. The method of claim 9, wherein the at least one connection element is associated with a directionality characteristic.

15. The method of claim 9, wherein the at least one connection element comprises at least one of a doorway, a ramp, an escalator, an elevator, or a stairway.

16. The method of claim 9, further comprising transmitting the digital wayfinding map to one or more logic devices using a transceiver operatively coupled to the processor.

17. A computer-readable storage medium having computer-readable program code configured to connect a plurality of map units of a digital wayfinding map embodied therewith, the computer-readable program code comprising:
computer-readable program code configured to access the plurality of map units, each of the plurality of map units comprising at least one of a plurality of nodes;
computer-readable program code configured to receive a plurality of portal nodes arranged on at least two of the plurality of map units;
computer-readable program code configured to receive at least one connection element configured to indicate a connection between at least two of the plurality of map units through at least two of the plurality of portal nodes; and
computer-readable program code configured to generate at least one multi-unit route between at least two of the plurality of nodes of the at least two map units using the at least one connection element.

18. The computer-readable storage medium of claim 17, further comprising computer readable program code configured to present the digital wayfinding map on a display component.

19. The computer-readable storage medium of claim 17, further comprising computer readable program code configured to present only map units along the at least one lowest-cost in the digital wayfinding map on the display component.

20. The computer-readable storage medium of claim 17, further comprising computer readable program code configured to transmit the digital wayfinding map to one or more logic devices over a network.
